(19) United States
(12) Patent Application Publication
(10) Pub. No.: US 2024/0123536 A1
(43) Pub. Date: Apr. 18, 2024

(54) WIRE GUIDE MODULE AND SYSTEM

(71) Applicant: ELCo Enterprises, Inc., Jackson, MI (US)

(72) Inventor: Edward L. Cooper, Clarklake, MI (US)

(21) Appl. No.: 18/275,422

(22) PCT Filed: Feb. 11, 2022
(86) PCT No.: PCT/US2022/016050

§ 371 Date: Aug. 2, 2023

Related U.S. Application Data
(60) Provisional application No. 63/148,365, filed on Feb. 11, 2021.

(51) Int. Cl. B23K 9/12

(52) U.S. Cl. CPC B23K 9/125; B23K 9/122

(57) ABSTRACT

A plurality of wire guide modules are interconnected and pivotally attached to each other. The wire guide modules are pivotable between straight configuration and a curved configuration. Each wire guide module defines a channel (22) extending longitudinally therethrough with bearings (24, 26, 28) on opposite lateral sides of the channel. The wire guide modules are defined by first (10a) and second (10b) halves that are joined together to define the channel and retain the bearings. Each wire guide module defines a slot portion (40a) at a first end and tongue portion (42a) at the second end. The tongue portion is sized to be received within the slot portion. The tongue portion defines a pivot hole and the slot portion defines pivot pins received in the pivot hole to define the pivot axis therebetween.

### CROSS-REFERENCE TO RELATED APPLICATIONS

This International PCT Application claims the benefit of U.S. Provisional Patent Application No. 63/148,365, entitled “WIRE GUIDE MODULE AND SYSTEM” filed Feb. 11, 2021, the entire content of which is hereby incorporated by reference in its entirety.

### FIELD

The present disclosure relates to a wire guide module for use in a wire dispensing system. More particularly, the present disclosure relates to a flexible guide module for use with large diameter wire.

### BACKGROUND

Welding systems, such as MIG welding systems, include the use of a consumable electrode that is fed from a wire storage container to a weld gun. The consumable electrode is heated and melted at the location where welding is desired, such that wire is constantly fed to the weld gun during the welding process when welding is occurring.

In some instances, the location of the weld gun and the welding operation can be located remotely relative to the wire storage container. Accordingly, the wire may be fed over a large distance to ultimately reach the location of the weld gun. Accordingly, a guiding structure through which the wire travels may be used. However, at extending lengths, friction can build up along the wire, requiring greater force to feed the wire or potentially damaging the wire due to the contact with the wire guide.

Additionally, the wire may need to fed in opposite directions through the guide depending on the state of the system. Wires can be of various diameter depending on the type of weld gun and size of the weld being created. Larger diameter wires can be more difficult to feed than smaller diameter wires, having greater weight as well as surface area, and being more difficult to bend, which increases friction on the wire, especially around bends, and/or when the feed direction is reversed.

There remains a need for a wire guide module which enables the direction of a wire in a wire dispensing system to be changed without substantially increasing the drag on the wire and for use with large diameter wires.

### SUMMARY

According to an aspect, a wire guide module for feeding large diameter wire is provided, including: a housing having a having a first end and a second end, wherein the main body extends longitudinally between the first end and the second end; a slot portion defined at the first end of the housing; a tongue portion defined at the second end of the housing, the tongue portion having a thickness generally corresponding to a space defined by the slot portion, such that the tongue portion of the module is receivable within the slot portion of an identical further housing; a first port defined at the slot portion and a second port defined at the tongue portion and a channel extending longitudinally from the first port to the second port for feeding the wire therethrough; wherein the channel includes a central section extending parallel to the longitudinal axis of the housing and the channel further includes a tapered portion extending from the central section toward the first port or the second port; at least two rotatable bearings disposed in the main body on opposite lateral sides of the channel, wherein the bearings are configured to contact and feed the wire through the channel.

In one aspect, the housing defines a first edge and second edge on opposite lateral sides of the housing, wherein the first edge has a concave curvature and the second edge has a convex curvature.

In one aspect, the tapered portion of the channel defines opposing first and second tapered edges, wherein the second tapered edge extends parallel to the central section of the channel and the first tapered edge extends at an oblique angle relative to the central section in a direction toward the first edge of the housing.

In one aspect, the at least two bearings comprise three bearings, wherein a first bearing is disposed on a first side of the channel closest to the first edge of the housing, and second and third bearings are disposed on a second side of the channel closest to the second edge.

In one aspect, the first, second, and third bearings are equally spaced relative to each other.

In one aspect, the first bearing is disposed longitudinally between the second and third bearings.

In one aspect, the first port is an outlet port and the second port is an inlet port.

In one aspect, first port is recessed relative to the first end and the second port is flush with the second end.

In one aspect, the housing includes a first half and a second half joined together at a mating plane, wherein the channel is defined by both the first half and the second half.

In one aspect, the first half and second half are mirrored shapes across the mating plane.

In one aspect, the tongue portion is defined by both the first half and the second half, wherein the first and second halves each include a tongue flange that meets at the mating plane.

In one aspect, the slot portion is defined by both the first half and the second half, wherein the first and second halves each include a slot flange that are spaced apart on opposite sides of the mating plane.

In one aspect, the tongue portion includes a pivot hole extending through the flange portion and a curved slot extending through the flange portion, wherein the slot portion includes a post and a pin, wherein the post is sized to be received in the pivot hole of another module and the pin is sized to be received and moveable within the curved slot of another module.

In one aspect, the pivot hole, curved slot, pin, and post are on the same lateral side of the channel.

In one aspect, the curved slot is laterally offset relative to the pivot hole, and the pin is laterally offset relative to the post.

In another aspect, a flexible wire guide module system includes: a plurality of interconnected wire guide modules including at least a first wire guide module and a second wire guide module, each wire guide module of the plurality of interconnected wire guide modules including: a slot portion defined by a pair of slot flanges at a first longitudinal end of the module; a tongue portion defined by a pair of tongue flanges at a second longitudinal end of the module; a module channel extending between a first port at the first and a second port at the second end; a plurality of bearings disposed within the module adjacent the module channel including at least one bearing on each lateral side of the module channel; wherein the first and second modules are pivotally connected via a positive connection fit between the tongue portion of the first module and slot portion of the second module; an overall channel comprising each of the module channels, wherein the overall channel changes depending on a relative orientation of each module.

In one aspect, the plurality of modules are pivotally adjustable between a straight configuration and a curved configuration.

In one aspect, each module is pivotable relative to an adjacent module in only a single direction relative to the straight configuration.

In one aspect, the system includes a first terminal attached to a first end of the plurality of modules and a second terminal attached to a second end of the plurality of modules, wherein the first and second terminals each include a port for receiving or providing a wire therethrough, wherein the first terminal includes a tongue portion in a positive connection fit with the slot portion of the wire guide module at the first end, and the second terminal includes a slot portion in a positive connection fit with the tongue portion of the wire guide module at the second end.

In another aspect, a method of interconnected a plurality of wire guide modules is provided. The method includes the steps of: providing a first half of a wire guide module, wherein the first half includes a slot flange at a first end and a tongue flange at a second end, wherein the slot flange includes post projecting therefrom and the tongue flange defines pivot hole extending therethrough; placing a plurality of bearings adjacent a channel defined in part by the first half and extending longitudinally between the first end and the second end, wherein the bearings are placed on opposite lateral sides of the channel; providing a second half of a wire guide module, wherein the second half includes a slot flange at a first end and a tongue flange at a second end, wherein the slot flange includes a post projecting therefrom and the tongue flange defines pivot hole extending therethrough; attaching the second half of a wire guide module to the first half and capturing the bearings therebetween, wherein the tongue flanges of the first and the second half combine to define a combined tongue portion defining a combined pivot hole therethrough; in response to attaching the second half to the first half, defining an assembled first wire guide module; after defining the first wire guide module, attaching a further first half of a wire guide module to the combined tongue portion by inserting the post of the further first half into the combined pivot hole of the combined tongue portion; attaching a further second half of a wire guide module to the combined tongue portion by inserting the post of the further second half into the combined pivot hole of the combined tongue portion; disposing further bearings between the further first and second halves; in response to attaching the further first and second halves to the combined tongue portion and disposing further bearings therebetween, defining a further combined wire guide module; wherein the first wire guide module and the further wire guide module are pivotally connected in positive locking engagement therebetween.

Further objects, features, and advantages of this invention will become readily apparent to persons skilled in the art after a review of the following description, with reference to the drawings and claims that are appended to and form a part of this specification.

### BRIEF DESCRIPTION OF THE DRAWINGS

FIG. 1 illustrates a single wire guide module disposed between two terminals;

FIG. 2 illustrates a cross-sectional view of the wire guide module and terminals of FIG. 1 taken along a central mating plane and illustrating a plurality of roller bearings;

FIG. 2A is an exploded view of wire guide module illustrating internal bearings and a post and a pin sized and arranged to be receive in a corresponding hole and curved slot or an adjacent module;

FIG. 3 illustrates a plurality of wire guide modules connected to each other in a slightly curved configuration;

FIG. 4 illustrates the plurality of wire guide modules of FIG. 3 connected to a cable carrier;

FIG. 5 is a front view of a plurality of interconnected wire guide modules arranged in a straight configuration;

FIG. 6 is an end view of the modules of FIG. 5;

FIG. 7 is a front view of a plurality of interconnected modules arranged in a curved configuration;

FIG. 8 is an end view of the modules of FIG. 7; and

FIG. 9 is a perspective view of the modules of FIGS. 7 and 8 attached to a cable carrier.

### DETAILED DESCRIPTION

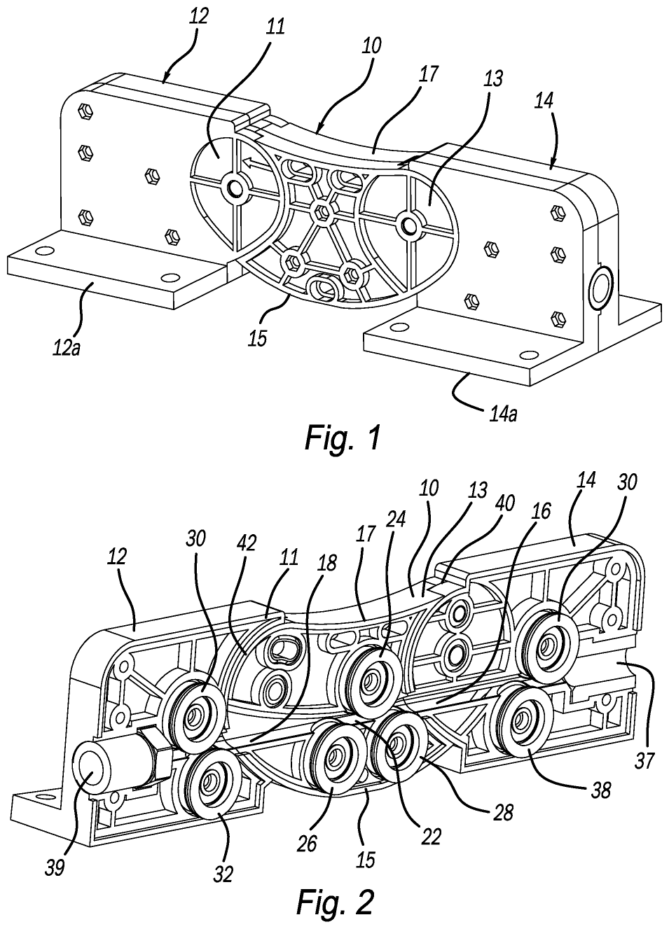

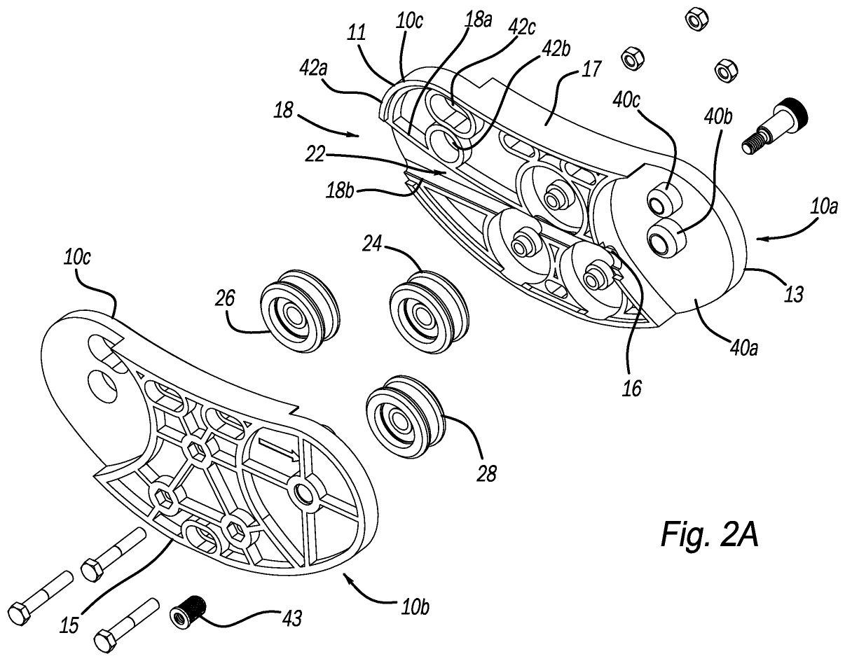

Referring initially to FIGS. 1 and 2, a single wire guide module 10 is shown. It will be appreciated that this wire guide module 10 can be connected to additional wire guide modules of the same construction in a chained manner, as further described below. Initially, the single wire guide module 10 will be described. FIG. 1 illustrates a wire guide module 10 with terminal portions 12 and 14 attached to opposite ends of the module 10. In the case of multiple modules chained together, the terminals 12 and 14 may be attached to opposite ends of the chain of connected modules, as further described below.

FIG. 2 illustrates a cross-sectional view of FIG. 1, and illustrates internal components of the wire guide module 10 as well as the terminals 12, 14. The cross-section is taking along a central longitudinal plane of the wire guide module 10 and terminals 12, 14. As further described below, the terminals 12, 14 may connect to opposite ends of the module 10 or the chain of modules 10 in a positive locking manner such that portions of the terminals 12, 14 are received within the ends of the wire guide module 10 or chain of modules 10, and vice versa. This positive connection can be seen in FIG. 2.

Here, the wire guide module 10 generally has a first end 11 that extends longitudinally towards a second end 13. The wire guide module 10 may have a first surface 15 (or lower edge 15) and a second surface 17 (or upper edge 17) that also extend between the first end 11 and the second end 13 on generally opposing sides of the wire guide module 10. In this example, the first surface 15 may be substantially convex in shape. The second surface 17 may be flat or may be slightly concave in shape.

In one aspect, multiple wire guide modules 10 may be connected together to define an elongated guide path for a wire to be fed therethrough. The wire guide modules 10 are sized and arranged to be moveable relative to each to define various orientations and curvatures relative to each other in order to define a path for the wire along a desired curvature.

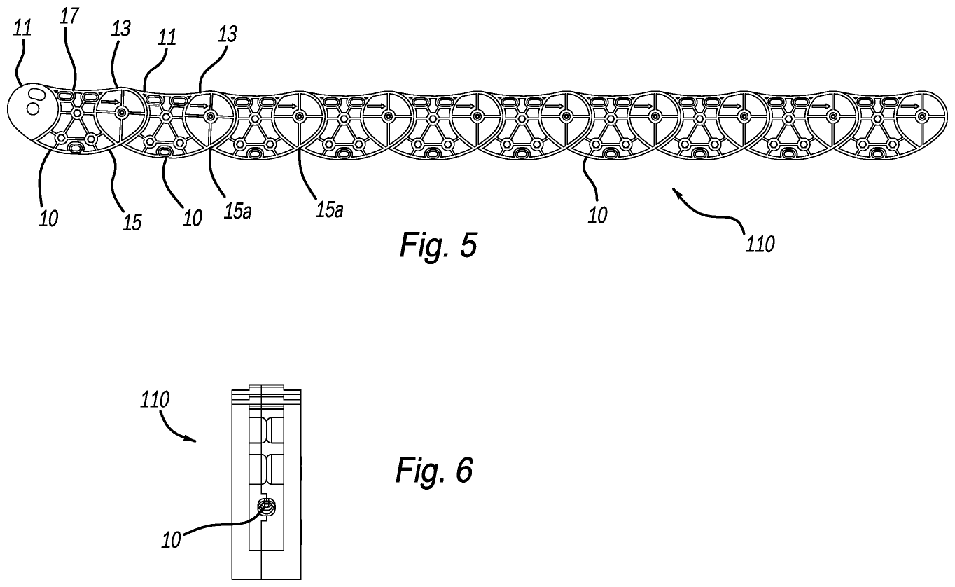

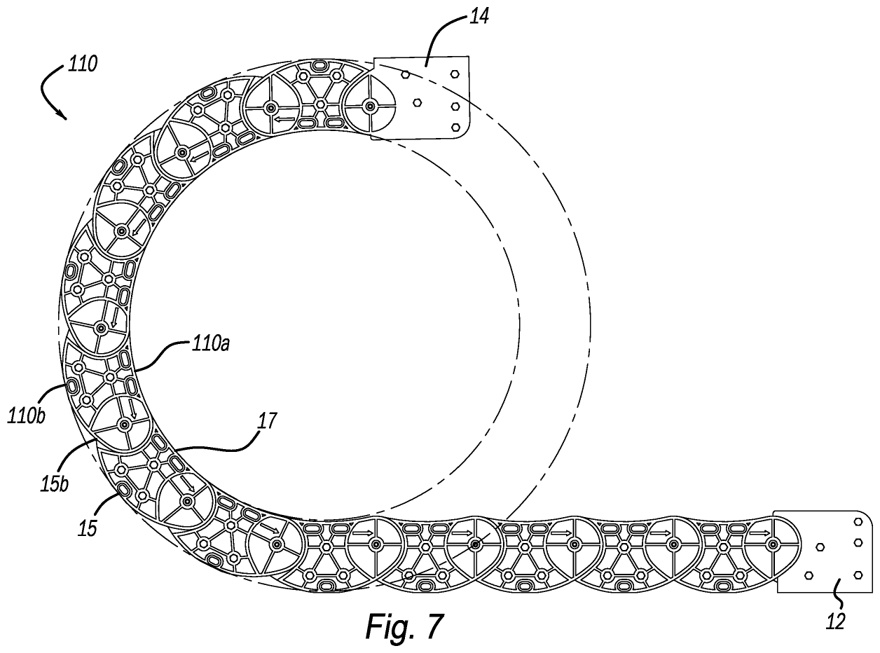

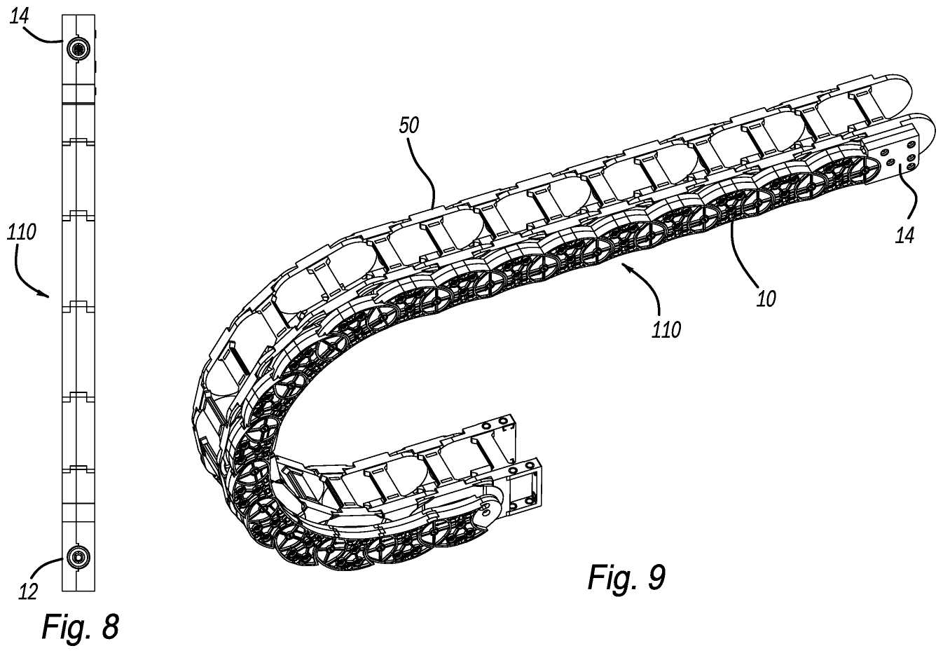

FIG. 5 illustrates a chain 110 of wire guide modules 10 connected together to define a straight path. FIG. 6 illustrates an end view of the chain of modules 10 and showing a clear path extending therethrough. FIG. 7 illustrates the chain 110 in a curved and straight configuration extending between terminals 12 and 14. FIG. 8 illustrates an end view of the curved and straight configuration of FIG. 7. FIG. 9 illustrates this curved and straight configuration attached to a cable carrier.

In one aspect, shown in FIGS. 5 and 6, the wire guide modules 10 may be oriented and arranged to define generally straight path, with each wire guide module 10 feeding into an adjacent wire guide module 10 such that the wire does not bend or turn as it travels through the modules 10. It will be appreciated that some slight bending or bowing of the wire may naturally occur even when the wire is being fed along a straight path.

As shown in FIG. 5, a series of wire guide module 10 are connected end-to-end. Put another way, the right side or end 13 of the module 10 at the far left side of the series of modules 10 is attached to the left side or end 11 of the immediately adjacent module 10 in the figure. As shown, the upper edge 17 of the modules 10 generally define a straight path, with a series of small curvatures or indentations centered on each modules 10.

Moving from left to right along the series of modules 10 in FIG. 5 along the upper edges 17, the left side of the module 10 defines a convex outer curvature, which smoothly transitions into concave curvature along the midsection of the module 10, which then smoothly transitions into convex curvature, which overlaps with the adjacent connected module 10. Adjacent modules continue to overlap at the convex portions, and the concave portions at the midsection generally do not overlap along the upper edges 17 of the series of modules 10.

Thus, the upper profile of the series or chain 110 of connected modules 10 defines a generally undulating profile/edge when the modules 10 are aligned in a straight path as shown in FIG. 5. The degree of undulation is evenly distributed. Put another way, a straight notational line may be drawn tangential to the outermost portion of each of the modules 10. Similarly, a straight notational line may be drawn tangential to the innermost portion of the modules 10 when the modules 10 are aligned in the straight arrangement. These lines are evenly spaced along the length of the chain 110 and parallel when the chain 110 is straight as shown in FIG. 5.

The lower edges 15 are distinguishable from the upper edge 17, in that the midsection of each module 10 is convex, and the convex curvature extends continuously between the terminal ends 11, 13 of each module 10. Thus, when aligned in the straight arrangement, a recess 15a is defined at the overlap of the modules 10. The recess 15a has a generally V-shape, which can be defined as a sharp corner or a concave profile with a pointed base.

Similar to the upper edge of the series of modules, the notational lines may be drawn through various corresponding structure along the series of modules 10. For example, when in the straight configuration, a notational line drawn through the base of the recesses 15a defined by the overlaps of the modules 10 will be straight. A notational line drawn through the outermost point of the modules 10 will be straight.

As the modules 10 are attached together in series, the modules 10 are pivotable relative to each other. In one aspect, the series of modules 10 may be bent relative to each other to define a 180 degree turn, as shown in FIG. 7. Put another way, a wire being fed through the modules 10 in a first direction will be caused to bend and turn back to be fed in a second direction opposite the first direction.

In one aspect, the modules 10 may be arranged relative to each other such that a predetermined number of modules 10, when pivoted a maximum amount relative to each other, define a 180 degree bend. In one aspect, eight (8) modules 10 may be attached in series to define a 180 degree turn,

When the modules 10 are in a curved configuration to define the 180 degree turn, the module 10 may combine to define curved inner profile 110a that is substantially smooth and free from recesses, bumps, waves, indentations, or the like, as shown in FIG. 7. In one aspect, the modules 10 may combine to define a semi-circular profile 110a that is smooth and without said recesses or indentations.

In the curved configuration, an outer profile 110b may be defined that includes a plurality of outer recesses 15b, similar to the v-shaped recesses previously described for the straight profile. The outer recesses 110c in the curved configuration may have a smaller depth than the outer recesses 15a that are defined between the modules 10 in the straight configuration.

In the curved configuration, a radiused notational line may be drawn along the inner edge of the modules 10, with the radiused notational line substantially overlying the entire edge 17 of multiple modules 10. This notational line may define a first diameter. In one aspect, the first diameter is 17.165 inches.

In the curved configuration, an outer radiused notional line may be drawn through the outermost point of the modules 10, intersecting each module at a single point. In one aspect, the outer radiused notational line may have a diameter of 23.450 inches.

While both a straight configuration and a 180 degree curved configuration have been shown and described, it will be appreciated that other intermediate configurations may also be created, by varying the amount of relative pivoting between each module 10. When each of a group of modules 10 are pivoted the same amount, the defined curvature will be relatively the same. In another aspect, the modules 10 may be pivoted relative to each other at different amounts, thereby creating a complex curvature that varies its radius. In one aspect, when the modules 10 defining the curvature are pivoted the same amount, internal channel 22 defined by the modules 10 for feeding the wire will have a generally constant radius along the curved path. When the modules 10 are pivoted at different degrees relative to each other, the internal channel 22 may have a varying radius.

The wire guide module 10 may include input port 18 as well as output port 16. Located between input port 18 and output port 16 is channel 22. Channel 22 extends from output port 16 to input port 18. In one example, the wire may be fed through input port 18 through channel 22 all the way to output port 16.

In one aspect, output port 16 may be recessed relative to the corresponding end 13 of the module 10, with input port 18 being generally adjacent the corresponding end 11 of the module 10. It will be appreciated that input port 18 and output port 16 are so described in relation to a given feed direction of the wire. However, the wire may be reversed in its feed direction, or the wire may be initially fed through the modules 10 in an opposite direction. Accordingly, input port 18 and output port 16 may also be referred to as first port 18 and second port 16, respectively. Thus, second port 16 may be recessed relative to its corresponding edge, and first port 18 may be disposed generally adjacent its corresponding edge.

In one aspect, first port 18 may define a tapered shape, such that an outermost portion of first port 18 is wider than an innermost portion of first port 18. Second port 16, on the other hand, may have a generally constant width. First port 18 and second port 16 may also define a portion of the length of channel 22, with an intermediate portion of channel 22 connecting first port 18 and second port 16.

A first edge 18b of the tapered shape may be aligned with the straight path for the wire when the modules 10 are in the straight configuration. When the modules 10 are in the straight configuration, a second edge 18a, opposite the first edge 18b, may be arranged at an oblique angle relative to the straight path of the wire. Accordingly, the first edge 18b of the first port 18 is generally aligned with the second port 16 of the adjacent module 10 when the modules 10 are in the straight configuration.

When the modules 10 are in the curved configuration, the second edge 18a is aligned with the curved path of the wire. The first edge 18b is aligned at an oblique angle, generally tangentially, to the curved path of the wire. Accordingly, the second edge 18a is generally aligned with the second port 16 of the adjacent module 10 when the modules 10 are in the curved configuration.

The second port 16 can be generally non-tapered, at least relative to the tapered shape of the first port 18. This is because the second port 16 is recessed from the edge of the module 10. When the modules are assembled, the first ports 18 are made to meet with the recessed second ports 16. Put another way, when the modules 10 pivot relative to each other, the second port 16 can be said to remain fixed, with the first port 18 shifting relative to the fixed second port 16 inside of the module 10 that contains the fixed second port 16. Alternatively, because the movement of the modules 10 are relative to each other, the first port 18 can be said to be fixed, with the second port 16, which is disposed outside of the profile of the module 10 having the adjacent first port 18, pivoting or shifting along the relatively wide opening of the first port 18.

Whether straight or curved, the wire may be fed through the series of connected modules 10 in both directions through the series or chain 110 of modules 10. Put another way, the wire may be fed through the inlet port 18 toward the outlet port 16 or each module, such that the wire enters the wide and tapered shape of the inlet port 18, and exits the straight and narrow end of the outlet port 16, and is then fed into the adjacent inlet port 18, which is aligned with the outlet port 16 regardless of being straight or curved relative to each other. The wire may therefore also be fed in the opposite direction into the narrow opening of the outlet port 16, through the module 10, and out of the wide and tapered opening of the inlet port 18, and into adjacent outlet port 16, regardless of straight or curved configuration.

The primary feed direction of the wire may be in either direction relative to the series of modules 10, and the wire may be backed-up opposite the primary feed direction, if necessary. The wire may therefore be pushed or pulled through the series of modules 10. The modules 10 are arranged such that the wire will pass through the series of modules 10 with reduced friction or resistance, regardless of direction of feed and regardless of being pushed or pulled. It will be appreciated that resistance may still vary depending on direction and whether the wire is pushed or pulled.

Located within the wire guide module 10 are bearings 24, 26, and 28, shown in FIG. 2. The bearing 24 may be located on one side of the channel 22, while bearings 26 and 28 may be located on an opposite side of the channel 22. As such, as the wire is fed through the channel 22, the bearings 24, 26, and/or 28 have the ability to reduce friction to allow the wire to travel through the wire guide module 10 more easily.

As shown in FIGS. 2 and 2A, each module 10 may include the three bearings 24, 26, 28. Bearing 24 is disposed on a lateral side of the module 10 that is adjacent the radially inner side of the module 10 when the series 110 of modules 10 are disposed in their curved configuration. Bearing 24 may therefore be referred to as inner bearing 24, or may also be referred to as first bearing 24.

Bearings 26 and 28 are opposite inner bearing 24. When the modules 10 are in the curved configuration, the bearings 26, 28 are on the radially outer side of the modules 10. Accordingly, the bearings 26 and 28 may be referred to as outer bearings 26 and 28, and may also be referred to as second bearings 26 and 28.

Bearings 24, 26, and 28 are arranged in an alternating fashion, with bearing 24 being disposed longitudinally between bearings 26 and 28. Bearing 24 combines with bearings 26 and 28, therefore, to effectively define an inlet and outlet within the cluster of bearings. Bearings 26 and 28 are on the same side of the wire when the wire is passing through the module. Bearing 24 is on the opposite side of the wire relative to the bearings 26 and 28 when the wire is passing through the module 10.

Bearing 24 and 28 are disposed adjacent outlet port 16, with bearing 28 being disposed longitudinally closer to the outlet port 16. In one aspect, bearing 28 defines a portion of outlet port 16. In a case where the wire makes contact with both bearings, a given point on the wire would make contact with bearing 28 prior to making contact with bearing 24 when entering the module via outlet port 16.

Bearing 24 and 26 are disposed adjacent inlet port 18 In particular, bearings 24 and 26 are disposed adjacent the narrow end of the tapered shape of inlet port 18. Wire passing through the bearings 24, 26 will exit the central section of the module 10 and enter the tapered shape of inlet port 18. Alternatively, wire passing through the tapered shape of the inlet port 18 (in a direction toward the bearings 24, 26) will reach the narrow end of the inlet port 18 prior to entering the bearings 24 and 26. A given point on the wire will contact bearing 24 prior to contacting bearing 26 when the wire is moving from the outlet port 18 toward the tapered inlet port 16. A given point on the wire will contact bearing 26 prior to contacting bearing 24 when the wire is moving from the inlet port 18 toward the outlet port 16.

In one aspect, the bearings 24, 26, 28 are arranged in a triangular pattern, such that a rotational axis of each bearing 24, 26, 28 is spaced approximately the same distance from each of the other two bearings. Put another way, a notational line connecting each axis of the bearings 24, 26, and 28 will define an equilateral triangle.

In one aspect, when more than one adjacent modules 10 are connected and arranged in a “straight” configuration, the bearings 26 and 28 of the first module will be substantially aligned with the bearings 26 and 28 of the adjacent module 10. Similarly, each of the bearings 24 of the adjacent modules 10 will be aligned. A notional line running through the pairs of bearings 26, 28 will be parallel to a line running through the bearings 24.

When modules 10 are arranged in a curved manner, bearings 24 will be radially inward from the wire passing through the modules 10. Bearings 26 and 28 will be disposed radially outward from the wire passing through the modules 10.

The straight and curved configurations of the modules 10 have been previously described. The shape of the modules 10 at opposite ends thereof can be arranged to physically limit the degree to which the modules 10 may pivot relative to each other. When the modules 10 are arranged in a straight configuration, respective edges 15 of the modules 10 may be in contact with each other and may bear against each other such that the modules 10 are preventing from pivoting beyond the straight configuration in the direction of the upper edges. The edges 17 of the modules may be spaced apart from each other, thereby allowing the modules 10 to pivot in the direction of the edges 17 (toward a curved configuration), such that the space between the adjacent edges 17 is taken up as the modules move. As the modules 10 are pivoted toward the curved configuration, the edges 15 of adjacent modules 10 will move away from each other, and will increase space therebetween as the modules 10 continue to pivot.

When the modules 10 have reached the curved configuration, the edges 17 of adjacent modules 10 will abut each other, preventing further pivoting and limiting the amount of curvature. The edges 17 that contact each other in either the straight or curved configuration are defined by the corresponding tongue and groove structures defined by the modules 10 that are correspondingly attached to each other when the modules 10 are linked in series. The structure of the tongue and groove portions of the modules 10 is described in further detail below.

The system may also include terminal members 12 and 14 attached to the respective ends of the series of modules 10, with one attaching to the tongue portion of a module 10 at one end and the other attaching to the groove portion of a module 10 at the opposite end. Terminal portions 12 and 14 function so as to provide either an input for inserting a wire from the wire roll or as an output for providing the wire to the welding tool. Here, the terminal end 14 includes port 37. The port 37 may be made of a metal, such as brass, so as to aid the insertion of the wire. The terminal portion 12 includes a port 39 that also may be made of brass. Again, the purpose of making the port 39 out of brass or any other metal is so to allow the easy ejection or insertion of the wire through the terminal end 12. The terminal members 12 and 14 may include flange portions 12a and 14a, respectively, that can be fixed in place in the work area, allowing the modules 10 that are connected therebetween to slightly flex and bend while still delivering the wire from a predetermined inlet position to a predetermined outlet position as defined by the fixed position of the terminal members 12 and 14.

The terminal end 14 may also include bearings 36 and 38 so as to reduce friction and promote the feeding of the wire through the module 10 or series of modules 10, while the terminal end 12 may include bearings 30 and 32 to enhance the passage of the wire through the modules 10 by reducing friction. Bearings 36 and 38 may be opposite sides of the wire when the wire is passing through the system. Bearings 30 and 32 may also be on opposite sides of the wire. Bearings 36 and 38 may be offset relative to each other, such that a given point on the wire will contact bearing 36 at a different time relative to bearing 38. Similarly, bearings 30 and 32 may be offset, with the wire contacting bearing 32 at a different time relative to bearing 30. Which bearing is contacting first depends on the direction of movement of the wire. Bearings 30 and 36 are disposed closer to the respective ports of the terminal members 12, 14. Bearings 32 and 38 may be disposed closer to the attached module 10. When the terminal members 12 and 14 are arranged in a straight configuration with the module 10 or modules 10 also in a straight configuration, the bearings 32 and 38 are aligned with bearings 26 and 28 of the modules 10, and bearings 30 and 36 are aligned with bearing 24.

As shown in FIG. 2, terminal member 14 defines a tongue portion that is received in a groove/slot of module 10. Terminal member 12 defines a groove or slot portion that receives a tongue portion of the module 10. The tongue/slot configurations are described further below.

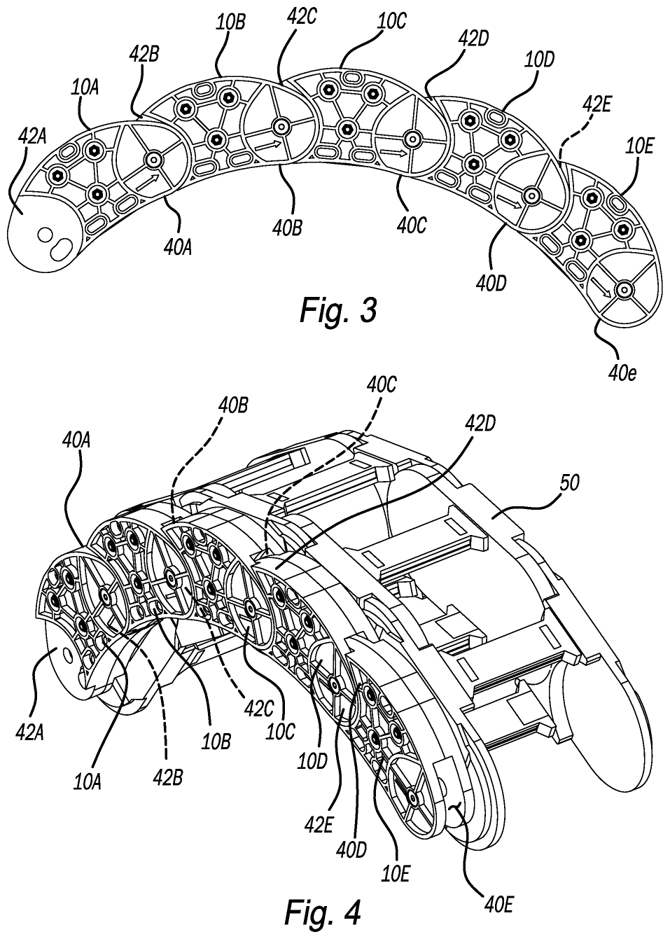

As stated before, the module 10 is configured to connect to other modules. In order for this to happen, the module 10, on the end 11 may have a tongue 42. On the other end 13, the module 10 may have a slot 40. The slot 40 generally has a cross-section such that the tongue 42 can fit into the slot 40 of another module 10. As such, as best shown in FIG. 3, modules 10A, 10B, 100, 10D, and 10E can all connect to one another by inserting the appropriate tongue 42 into the appropriate slots 40.

With reference to FIGS. 2 and 3, therefore, the tongue 42A may be received in slot portion of terminal 12. Similarly, slot 40E may receive tongue portion of terminal 14.

Each module 10 in a series 110 of modules, in addition to being received in an adjacent module 10, is also retained relative to an adjacent module 10 by the modules 10 themselves. The modules 10 are formed by combining two halves 10a and 10b, as shown in FIG. 2A. It will be appreciated that the halves 10a, 10b may not necessarily be symmetrical or perfectly half, but rather opposing portions that are joined together via fasteners or the like.

The passageway or channel 22 for the wire is defined by joining the halves 10a, 10b together. Similarly, the cavities or recesses for retaining the bearings of each module 10 are defined by joining the halves together.

For purposes of discussion, the module 10 will be further described as having a tongue end (end 11 that defines tongue 42) and a slot end (end 13 that defines slot 40). The tongue end of the module 10 defines the tongue 42 when the halves are assembled, and the slot end of the module 10 defines the slot 40 when the halves are assembled. The halves 10a and 10b may also be described as a first half 10a and second half 10b.

The first half 10a defines a central mating plane/surface 10c of the module 10. The passageway 22 may be formed partially as a groove formed in this surface. A slot flange 40a at the slot end of the module 10 is recessed relative to the mating surface 40c, thereby defining a stepped surface and an open space into which a corresponding tongue 42 may be received. At the tongue end of the module 10, tongue flange 42a is generally coplanar with the mating surface 10c. The thickness at the tongue 42 is less than the thickness of the central portion of the module. This reduced thickness portion of the tongue flange 42a defines half of the tongue 42, and is sized and arranged to be received in a corresponding space of the slot end of the adjacent module 10.

The tongue flange 42a defines a pivot hole 42b in which a corresponding post 40b from an adjacent module 10 is received. The post 42b may be hollow to allow for a fastener 43 to pass therethrough. Thus, the module 10 will pivot about this connection between adjacent modules 10. The tongue flange 42a further defines a curved slot 42c with a radius centered on the pivot hole 42b. The curved slot 42c has a curved length that corresponds to the amount of pivoting desired/permitted between adjacent modules 10. The curved slot 42c receives a pin 40c that projects from the corresponding slot flange 40a of the adjacent module 10. When the modules 10 are straight, the pin 40c is positioned at one of the end curved slot 42c. When the modules 10 are curved and pivoted, the pin 40c is positioned at the opposite end of the curved slot 42c.

When a single module 10 is assembled, pins and posts from opposite slot flanges 40a will be generally joined together at mating place 10c to define a combined pin or post. Similarly, slots or holes within the tongue flange 42a will join together to define a combined slot or hole. Thus, when a single module 10 is assembled, the module 10 will be generally prevented from being inserted into a module 10 or to receive another module 10, because the tongue would impact the combined pin and post, and the combined pin and post could not be received into the combined slot or pivot hole.

Thus, to interlink a plurality of modules 10, the plurality of modules 10 may be assembled with corresponding first halves being connected, followed by the installation of the second halves after the desired number of first halves have been connected.

In one example, a first half 10a is provided for subsequent assembly with additional first halves 10a. A further first half 10a is provided and attached to the initial first half 10a. The post 40b projecting from the slot flange 40a is accessible, as is the hole 42b into which the post 40b is received. The curved slot 42c of one of the halves 10a is similarly placed over the pin 40c.

With the pivot pins and posts received in the curved slots and pivot holes of the adjacent module 10, adjacent modules 10 are connected, and the bearings 24, 26, 28 may be placed in their corresponding recess formed within the first halves 10a. The bearings may be placed in the first halves 10 prior to connecting to adjacent first halves 10a, or after the first halves 10a have been connected.

With the bearings 24, 26, and 28 disposed and retained in the first halves 10a, the second halves 10b may be placed onto the connected adjacent first halves 10a. An initial second half 10b may be placed onto one of the halves 10a, such that the bearings 24, 26, and 28 are captured. The pivot hole 42b and curved slot 42c of second half 10b will be aligned with the pivot hole 42b and curved slot 42c of the corresponding first half 10a. After this initial second half 10b is placed on its corresponding first half 10a, the pivot hole 42b and curved slot 42c of this second half 10b is exposed and accessible from the outer surface of this now assembled module 10.

With the pivot hole 42b and curved slot 42c exposed and accessible, a further second half 10b may be placed onto the initial assembled module 10. The pivot pin and post that projected toward the module 10 are inserted into the exposed pivot hole and curved slot. This further assembled module 10 now has its own pivot hole and curved slot exposed for receipt of a pivot pin and post of yet another further second half 10b.

This process of installing the second halves 10b may be repeated as necessary to fully enclose the bearings within the modules 10.

In one aspect, the process of providing a first half 10a and connecting a further first half 10a may be done in a first direction (for example to left to right). The slot flange 40a of the first module is exposed and presented for attachment to a further first module 10. The tongue flange 42a of the next module is placed on the slot flange 40a of the initial first half 10a, such that the further first half 10a is to the right of the initial first half 10a. The further first half 10a therefore has its own slot flange 40a presented and exposed for yet another first half 10a to be added to the right. Accordingly, a chain of first modules 10 may be assembled in this first direction.

Subsequently, the second halves 10b may be installed onto this chain in a second direction that is opposite the first direction. For example, the second halves 10b may be added to the above described chain in a right to left direction, until the chain of modules 10 is completed.

In one aspect, the pins 40c and posts 40b that are received in the corresponding holes or slots do not extend beyond the mating plane 10c between the halves 10a, 10b. Put another way, without installation of the bearings, the chain of first halves 10a could be slidable relative to the chain of the second halves 10b. However, the bearings 24, 26, 28 have a height that extends across the mating plane, thereby retaining the chains of halves 10, 10b relative to each other during installation. The halves 10a, 10b may be additionally secured together via a fastener of the like. The fastener may extend through the posts 40b of each module's slot flange 40a, which are positioned through the pivot holes 42b of tongue flanges 42a. The fasteners will hold the slot flanges together to hold the halves 10a, 10b together, allowing the tongue 42 to pivot relative to the slot 40.

In another aspect, one module 10 may be fully assembled, followed by assembly of another module 10, etc. For example, a first half 10a may be provided, and the bearings 24, 26, 28 may be placed therein. The second half 10b of this module 10 may then be placed on the first half 10a to enclose the bearings, thereby defining a completed tongue 42 of the module 10, having the curved slot 42c and the pivot hole 42b therein.

Following assembly of the two halves 10a, 10b, another first half 10a may be assembled on one side of the tongue portion of the previously assembled module 10. The bearings 24, 26, 28 may be disposed within this first half 10a, and then the second half 10b may be added to the assembly on the opposite side of the tongue portion of the previously assembled module 10. The halves 10a, 10b may be joined together by a fastener at the slot end of the module 10. Following this assembly of the second module 10, there are two modules 10 connected together, and the second module 10 presents a tongue 42 for a subsequent module to be attached to in the same manner as described above.

It will be appreciated that in this approach either the first half 10a or the second half 10b may be first joined to the tongue 42 of the previously assembled module 10 in the chain of modules 10, and that the bearings 24, 26, 28 can be placed in the cavity of either half 10a, 10b.

In another aspect, a combination of the above two assembly methods may be used, such as a chain halves 10a may be assembled followed by a chain of second modules, ultimately creating an assembled tongue portion of a module 10 at the end of the chain, at which point a first and second half 10a, 10b may be added to the end of the chain.

Furthermore, in each of the above assembly methods, the terminals 12 and 14 may be provided as the ends of the overall chain, and may therefore be assembled similarly (either at the end of a chain of halves or as the first/last assembled component in the chain). Similar to the modules 10, the terminals 12 and 14 have bearings and metal ports disposed therein, and these bearings and ports are installed within one of the halves of the terminals 12, 14 prior to installing the opposite half.

In one aspect, the terminal 14 defines a tongue portion with holes in which the pin/post of the slot 40 of the adjacent module 10 are received. Thus, the terminal 14 may be assembled first, followed by the adjacent module 10 being attached to the tongue portion of the of the terminal 14. The halves of the terminals 12 and 14 may be joined together via fasteners or the like, similar to the modules 10.

In one aspect, the holes in the tongue portion of terminal 14 are arranged such that the pin and post of the adjacent module 10 are received to prevent the adjacent module 10 from substantially moving or pivoting, as shown in FIG. 2. The passageway 22 for the wire extending through the terminal 14 is straight and does not flare out, such that the passageway joins with the straight and non-tapered outlet of the module 10. At the opposite side of the module 10, the port 18 is tapered, allowing the wire to extend from the terminal 12 into the module 10 even if the terminal 12 is pivoted relative to the adjacent module 10. As shown in FIG. 2, because the module 10 has a curved slot 42c at its tongue 42 and the terminal 12 provides a pin that can shift within the curved slot, the module 10 can pivot relative to the terminal 12 (which has slot flanges similar to the modules 10). In one aspect, the terminal 12 may include a projection that matches the shape of the curved slot of the module 10 to prevent pivoting therebetween. However, because the module 10 has a tapered port adjacent the terminal 12, a pivoted module 10 relative to terminal 12 does not affect the provision of the wire through of the module and the terminal 12.

Of course, it will be appreciated that FIG. 2 illustrates how terminal 12 and 14 may attached to the structure that is present at the opposite ends of the module 10. Typically, multiple modules 10 will be chained together, such that terminals 12 and 14 are not attached to the same module 10, but rather to the opposite ends of the chain of modules 10, with terminal 12 (which defines a slot) joined with the tongue 42 of the last module 10 of the chain and terminal 14 (which defines a tongue) joined with the slot 40 of the last module 10 on the opposite end of the chain.

The chain of modules 10 allows adjacent modules 10 to pivot relative to each other, such that the chain of modules can bend and flex to accommodate various installation requirements and pathways. Additionally, the resulting bent pathway defined by the chain of modules 10 can accommodate feeding the wire in both directions, such as when the wire is reversed. When the wire is pulled through the chain of modules 10 from the outlet, the wire may be put in tension and exert a force in an inward direction and against bearings 24 through a curved portion of the chain 110. When the wire is reversed, such as being pushed from the outlet end, the wire will bear against bearings 26 and 28. in both cases, the resistance on the wire is reduced by the bearings inside the modules 10 and disposed substantially along the entire path of the chain of the modules 10.

Similarly, wire being pulled from the inlet end will cause the wire to bear against bearing 24, and wire being pushed from the inlet end will cause the wire to bear against bearings 26 and 28.

As forces are exerted by the wire against the interior of the modules 10, the modules 10 may flex slightly relative to each other by pivoting relative to the pivotal connection therebetween.

in one aspect, as shown in FIGS. 4 and 9, the modules 10 may be connected to a cable carrier 50, such as cable carrier sold by Igus, Inc. of East Providence, Rhode Island. The cable carrier 50 can provide a structure for attaching other cables or the like associated with the welding system. The cable carrier can provide support for the chain 110 of modules 10 and can be adjusted to correspond to the curvature and path defined by the chain 110 of modules.

As a person skilled in the art will readily appreciate, the above description is meant as an illustration of an implementation of the principles of this invention. This description is not intended to limit the scope or application of this invention in that the invention is susceptible to modification, variation, and change, without departing from the spirit of this invention, as defined in the following claims.

1. A wire guide module for feeding large diameter wire, the module comprising:
a housing having a having a first end and a second end, wherein the main body extends longitudinally between the first end and the second end;
a slot portion defined at the first end of the housing;
a tongue portion defined at the second end of the housing, the tongue portion having a thickness generally corresponding to a space defined by the slot portion, such that the tongue portion of the module is receivable within the slot portion of an identical further housing;
a first port defined at the slot portion and a second port defined at the tongue portion and a channel extending longitudinally from the first port to the second port for feeding the wire therethrough;
wherein the channel includes a central section extending parallel to the longitudinal axis of the housing and the channel further includes a tapered portion extending from the central section toward the first port or the second port;
at least two rotatable bearings disposed in the main body on opposite lateral sides of the channel, wherein the bearings are configured to contact and feed the wire through the channel.

2. The wire guide module of claim 1, wherein the housing defines a first edge and second edge on opposite lateral sides of the housing, wherein the first edge has a concave curvature and the second edge has a convex curvature.

3. The wire guide module of claim 2, wherein the tapered portion of the channel defines opposing first and second tapered edges, wherein the second tapered edge extends parallel to the central section of the channel and the first tapered edge extends at an oblique angle relative to the central section in a direction toward the first edge of the housing.

4. The wire guide module of claim 2, wherein the at least two bearings comprise three bearings, wherein a first bearing is disposed on a first side of the channel closest to the first edge of the housing, and second and third bearings are disposed on a second side of the channel closest to the second edge.

5. The wire guide module of claim 4, wherein the first, second, and third bearings are equally spaced relative to each other.

6. The wire guide module of claim 4, wherein the first bearing is disposed longitudinally between the second and third bearings.

7. The wire guide module of claim 1, wherein the first port is an outlet port and the second port is an inlet port.

8. The wire guide module of claim 1, wherein the first port is recessed relative to the first end and the second port is flush with the second end.

9. The wire guide module of claim 1, wherein the housing includes a first half and a second half joined together at a mating plane, wherein the channel is defined by both the first half and the second half.

10. The wire guide module of claim 9, wherein the first half and second half are mirrored shapes across the mating plane.

11. The wire guide module of claim 9, wherein the tongue portion is defined by both the first half and the second half, wherein the first and second halves each include a tongue flange that meets at the mating plane.

12. The wire guide module of claim 11, wherein the slot portion is defined by both the first half and the second half, wherein the first and second halves each include a slot flange that are spaced apart on opposite sides of the mating plane.

13. The wire guide module of claim 12, wherein the tongue portion includes a pivot hole extending through the flange portion and a curved slot extending through the flange portion, wherein the slot portion includes a post and a pin, wherein the post is sized to be received in the pivot hole of another module and the pin is sized to be received and moveable within the curved slot of another module.

14. The wire guide module of claim 13, the pivot hole, curved slot, pin, and post are on the same lateral side of the channel.

15. The wire guide module of claim 14, wherein the curved slot is laterally offset relative to the pivot hole, and the pin is laterally offset relative to the post.

16. A flexible wire guide module system, the system comprising:
a plurality of interconnected wire guide modules including at least a first wire guide module and a second wire guide module, each wire guide module of the plurality of interconnected wire guide modules comprising:
a slot portion defined by a pair of slot flanges at a first longitudinal end of the module;
a tongue portion defined by a pair of tongue flanges at a second longitudinal end of the module;
a module channel extending between a first port at the first and a second port at the second end;
a plurality of bearings disposed within the module adjacent the module channel including at least one bearing on each lateral side of the module channel;
wherein the first and second modules are pivotally connected via a positive connection fit between the tongue portion of the first module and slot portion of the second module;
an overall channel comprising each of the module channels, wherein the overall channel changes depending on a relative orientation of each module.

17. The system of claim 16, wherein the plurality of modules are pivotally adjustable between a straight configuration and a curved configuration.

18. The system of claim 17, wherein each module is pivotable relative to an adjacent module in only a single direction relative to the straight configuration.

19. The system of claim 16 further comprising a first terminal attached to a first end of the plurality of modules and a second terminal attached to a second end of the plurality of modules, wherein the first and second terminals each include a port for receiving or providing a wire therethrough, wherein the first terminal includes a tongue portion in a positive connection fit with the slot portion of the wire guide module at the first end, and the second terminal includes a slot portion in a positive connection fit with the tongue portion of the wire guide module at the second end.

20. A method of interconnected a plurality of wire guide modules, the method comprising;
providing a first half of a wire guide module, wherein the first half includes a slot flange at a first end and a tongue flange at a second end, wherein the slot flange includes a post projecting therefrom and the tongue flange defines pivot hole extending therethrough;
placing a plurality of bearings adjacent a channel defined in part by the first half and extending longitudinally between the first end and the second end, wherein the bearings are placed on opposite lateral sides of the channel;
providing a second half of a wire guide module, wherein the second half includes a slot flange at a first end and a tongue flange at a second end, wherein the slot flange includes a post projecting therefrom and the tongue flange defines pivot hole extending therethrough;
attaching the second half of a wire guide module to the first half and capturing the bearings therebetween, wherein the tongue flanges of the first and the second half combine to define a combined tongue portion defining a combined pivot hole therethrough;
in response to attaching the second half to the first half, defining an assembled first wire guide module;
after defining the first wire guide module, attaching a further first half of a wire guide module to the combined tongue portion by inserting the post of the further first half into the combined pivot hole of the combined tongue portion;
attaching a further second half of a wire guide module to the combined tongue portion by inserting the post of the further second half into the combined pivot hole of the combined tongue portion;
disposing further bearings between the further first and second halves;
in response to attaching the further first and second halves to the combined tongue portion and disposing further bearings therebetween, defining a further combined wire guide module;
wherein the first wire guide module and the further wire guide module are pivotally connected in positive locking engagement therebetween.
